(19) United States
(12) Patent Application Publication
(10) Pub. No.: US 2025/0274249 A1
(43) Pub. Date: Aug. 28, 2025

(54) METHOD AND APPARATUS FOR DETERMINING PRECODING RESOURCE BLOCK GROUP PRG, METHOD AND APPARATUS FOR INDICATING PRECODING RESOURCE BLOCK GROUP PRG, AND USER EQUIPMENT

(71) Applicant: VIVO MOBILE COMMUNICATION CO., LTD., Dongguan (CN)

(72) Inventors: Zhi LU, Dongguan (CN); Lihui WANG, Dongguan (CN)

(73) Assignee: VIVO MOBILE COMMUNICATION CO., LTD., Dongguan (CN)

(21) Appl. No.: 19/208,564

(22) Filed: May 14, 2025

Related U.S. Application Data
(63) Continuation of application No. PCT/CN2023/128594, filed on Oct. 31, 2023.

(30) Foreign Application Priority Data
Nov. 18, 2022 (CN) 202211447378.7

(51) Int. Cl. H04L 5/00; H04L 5/14; H04W 72/0453; H04W 72/51

(52) U.S. Cl. CPC H04L 5/0094; H04L 5/14; H04W 72/0453; H04W 72/51

(57) ABSTRACT

A method for determining a precoding resource block group (PRG), a method for indicating a precoding resource block group (PRG), and a user equipment are provided. The method for determining a precoding resource block group (PRG) includes: receiving, by a user equipment, first information, where the first information includes at least one of configuration information or indication information that is used for determining a PRG granularity; and determining, by the user equipment, a PRG granularity of at least one downlink (DL) subband in a subband full duplex (SBFD) mode based on the first information.

### CROSS-REFERENCE TO RELATED APPLICATIONS

This application is a continuation of International Application No. PCT/CN2023/128594, filed Oct. 31, 2023, which claims priority to Chinese Patent Application No. 202211447378.7, filed Nov. 18, 2022. The entire contents of each of the above-referenced applications are expressly incorporated herein by reference.

### TECHNICAL FIELD

This application relates to the field of communication technologies, and specifically, to a method and an apparatus for determining a precoding resource block group PRG, a method and an apparatus for indicating a precoding resource block group PRG, and a user equipment.

### BACKGROUND

In a New Radio (NR) system, a network side device configures a Bandwidth Part (BWP) and/or a carrier for a User Equipment (UE) to perform data transmission. Specifically, in a full duplex scenario, in a downlink (Down Link, DL) slot, the network side device may configure a DL BWP for the UE and allocate an uplink frequency domain resource to the UE in the DL BWP; and in an uplink (UP Link, UL) slot, the network side device may configure an uplink BWP for the UE and allocate a downlink frequency domain resource to the UE in the uplink BWP. For a subband full duplex (SBFD), one SBFD subband includes one Resource Block (RB) or one consecutive set of RBs having a same transmission direction, which can improve resource utilization efficiency, and reduce latency.

Currently, a precoding resource block (Precoding Resource Block Group, PRG) is designed based on a size of a DL BWP. However, in an SBFD scenario, one DL BWP may be divided into a plurality of DL subbands. In this case, the PRG designed based on the DL BWP may no longer be applicable, which affects channel estimation accuracy and needs to be improved.

### SUMMARY

Embodiments of this application provide a method and an apparatus for determining a precoding resource block group PRG, a method and an apparatus for indicating a precoding resource block group PRG, and a user equipment, to design a PRG applied to an SBFD scenario.

According to a first aspect, a method for determining a precoding resource block group PRG is provided. The method includes:
receiving, by a user equipment, first information, where the first information includes at least one of configuration information or indication information that is used for determining a PRG granularity; and
determining, by the user equipment, a PRG granularity of at least one DL subband in a subband full duplex SBFD mode based on the first information.

According to a second aspect, a method for indicating a precoding resource block group PRG is provided. The method includes:
sending, by a network side device, first information to a user equipment, to enable the user equipment to determine a PRG granularity of at least one DL subband in a subband full duplex SBFD mode based on the first information, where the first information includes at least one of configuration information or indication information that is used for determining the PRG granularity.

According to a third aspect, an apparatus for determining a precoding resource block group PRG is provided. The apparatus includes:
a first receiving module, configured to receive first information, where the first information includes at least one of configuration information or indication information that is used for determining a PRG granularity; and
a first determining module, configured to determine a PRG granularity of at least one DL subband in a subband full duplex SBFD mode based on the first information.

According to a fourth aspect, an apparatus for indicating a precoding resource block group PRG is provided. The apparatus includes:
a first sending module, configured to send first information to a user equipment, to enable the user equipment to determine a PRG granularity of at least one DL subband in a subband full duplex SBFD mode based on the first information, where the first information includes at least one of configuration information or indication information that is used for determining the PRG granularity.

According to a fifth aspect, a user equipment is provided. The user equipment includes a processor and a memory, where the memory stores a program or instructions executable on the processor, the program or instructions, when executed by the processor, implementing the steps of the method according to the first aspect.

According to a sixth aspect, a user equipment is provided. The user equipment includes a processor and a communication interface. The communication interface is configured to receive first information, where the first information includes at least one of configuration information or indication information that is used for determining a PRG granularity; and the processor is configured to determine a PRG granularity of at least one DL subband in a subband full duplex SBFD mode based on the first information.

According to a seventh aspect, a network side device is provided. The network side device includes a processor and a memory, where the memory stores a program or instructions executable on the processor, the program or instructions, when executed by the processor, implementing the steps of the method according to the second aspect.

According to an eighth aspect, a network side device is provided. The network side device includes a processor and a communication interface. The communication interface is configured to send first information to a user equipment, to enable the user equipment to determine a PRG granularity of at least one DL subband in a subband full duplex SBFD mode based on the first information, where the first information includes at least one of configuration information or indication information that is used for determining the PRG granularity.

According to a ninth aspect, a communication system is provided. The system includes: a user equipment and a network side device, where the user equipment may be configured to perform the steps of the method for determining a precoding resource block group PRG according to the first aspect, and the network side device may be configured to perform the steps of the method for indicating a precoding resource block group PRG according to the second aspect.

According to a tenth aspect, a readable storage medium is provided. The readable storage medium stores a program or instructions, the program or the instructions, when executed by a processor, implement the steps of the method according to the first aspect, or implement the steps of the method according to the second aspect.

According to an eleventh aspect, a chip is provided. The chip includes a processor and a communication interface, where the communication interface is coupled to the processor, and the processor is configured to run a program or instructions, to implement the method according to the first aspect, or implement the method according to the second aspect.

According to a twelfth aspect, a computer program/program product is provided. The computer program/program product is stored in a storage medium, the computer program/program product, when executed by at least one processor, implementing the steps of the method according to the first aspect or the second aspect.

In embodiments of this application, because the user equipment may determine the PRG granularity of the at least one DL subband in the subband full duplex SBFD mode based on at least one of the configuration information or the indication information, that is, the user equipment may determine the PRG granularity for the DL subband, the user equipment can better adapt to the SBFD scenario, thereby improving channel estimation accuracy.

### BRIEF DESCRIPTION OF THE DRAWINGS

FIG. 1 is a block diagram of a wireless communication system according to an embodiment of this application;

FIG. 2 is a schematic diagram 1 of resource allocation in an SBFD scenario according to an embodiment of this application;

FIG. 3 is a schematic diagram 2 of resource allocation in an SBFD scenario according to an embodiment of this application;

FIG. 4 is a schematic flowchart of a method for determining a precoding resource block group PRG according to an embodiment of this application;

FIG. 5 is a schematic diagram of an application scenario of a method for determining a precoding resource block group PRG according to an embodiment of this application;

FIG. 6 is another schematic flowchart of a method for determining a precoding resource block group PRG according to an embodiment of this application;

FIG. 7 is another schematic flowchart of a method for determining a precoding resource block group PRG according to an embodiment of this application;

FIG. 8 is another schematic flowchart of a method for determining a precoding resource block group PRG according to an embodiment of this application;

FIG. 9 is another schematic diagram of an application scenario of a method for determining a precoding resource block group PRG according to an embodiment of this application;

FIG. 10 is a schematic flowchart of a method for indicating a precoding resource block group PRG according to an embodiment of this application;

FIG. 11 is a schematic structural diagram of an apparatus for determining a precoding resource block group PRG according to an embodiment of this application;

FIG. 12 is another schematic structural diagram of an apparatus for determining a precoding resource block group PRG according to an embodiment of this application;

FIG. 13 is another schematic structural diagram of an apparatus for determining a precoding resource block group PRG according to an embodiment of this application;

FIG. 14 is another schematic structural diagram of an apparatus for determining a precoding resource block group PRG according to an embodiment of this application;

FIG. 15 is a schematic structural diagram of an apparatus for indicating a precoding resource block group PRG according to an embodiment of this application;

FIG. 16 is a schematic structural diagram of a communication device according to an embodiment of this application;

FIG. 17 is a schematic diagram of a hardware structure of a user equipment according to an embodiment of this application; and

FIG. 18 a schematic diagram of a hardware structure of a network side device according to an embodiment of this application.

### DETAILED DESCRIPTION

The following clearly describes the technical solutions in embodiments of this application with reference to the accompanying drawings in embodiments of this application. Apparently, the described embodiments are some of the embodiments of this application rather than all of the embodiments. All other embodiments obtained by a person of ordinary skill in the art according to embodiments of this application fall within the protection scope of this application.

The specification and claims of this application, and terms “first” and “second” are used to distinguish similar objects, but are unnecessarily used to describe a specific sequence or order. It should be understood that the terms used in such a way are interchangeable in proper circumstances, so that the embodiments of this application can be implemented in other orders than the order illustrated or described herein. Objects distinguished by “first”, “second”, and the like are usually one type, and a quantity of objects is not limited. For example, a first object may be one or more than one. In addition, in the specification and the claims, “and/or” represents at least one of connected objects, and the character “/” generally represents an “or” relationship between associated objects.

It should be noted that, the technologies described in embodiments of this application are not limited to a Long Term Evolution (LTE)/an LTE-Advanced (LTE-A) system, and may further be applied to other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” may usually be used interchangeably in embodiments of this application. The described technology can be applied to the systems and radio technologies mentioned above, and can also applied to other systems and radio technologies. The following description describes a New Radio (NR) system for example objectives, and NR terms are used in most of the descriptions below, although these technologies are also applied to applications other than NR system applications, such as a 6^{th} Generation (6G) communication system.

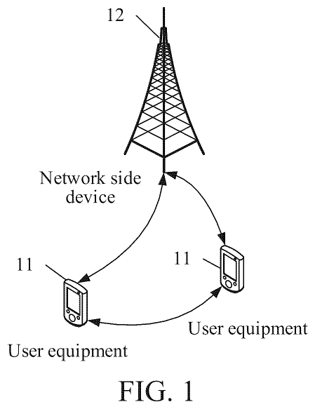

FIG. 1 is a block diagram of a wireless communication system to which an embodiment of this application can be applied. The wireless communication system includes a user equipment 11 and a network side device 12. The user equipment 11 may be a user equipment-side device such as a mobile phone, a tablet personal computer, a laptop computer or referred to as a notebook computer, a personal digital assistant (PDA), a palmtop computer, a netbook, an ultra-mobile personal computer (UMPC), a mobile Internet device (MID), an augmented reality (AR)/a virtual reality (VR) device, a robot, a wearable device, a vehicle user equipment (VUE), a pedestrian user equipment (PUE), smart household (home devices having a wireless communication function, for example, a refrigerator, a television, a washing machine, or furniture), a game console, a personal computer (PC), a teller machine, or a self-service machine. The wearable device includes: a smart watch, a smart wristband, smart headphones, smart glasses, smart jewelry (such as a smart bangle, a smart bracelet, a smart ring, a smart necklace, a smart anklet bangle, and a smart anklet), a smart wrist strap, smart clothes, and the like. It should be noted that, a specific type of the user equipment 11 is not limited in embodiments of this application. The network side device 12 may include an access network device or a core network device, where the access network device may also be referred to as a radio access network device, a radio access network (RAN), a radio access network function, or a radio access network unit. The access network device may include a base station, a wireless local area network (WLAN) access point, a wireless fidelity (WiFi) node, and the like, where the base station may be referred to as a Node B, an evolved Node B (eNB), an access point, a base transceiver station (BTS), a radio base station, a radio transceiver, a basic service set (BSS), an extended service set (ESS), a home Node B, a home evolved Node B, a transmission reception point (TRP) or some other suitable terms in the field. Provided that the same technical effects are achieved, the base station is not limited to a specific technical term. It should be noted that, only a base station in the NR system is used as an example for description, and a specific type of the base station is not limited in embodiments of this application.

To design a Precoding Resource Block Group (PRG) applied to a subband full duplex (SBFD) mode, to improve channel estimation accuracy, an embodiment of this application provides a method for determining a precoding resource block group PRG and a method for indicating a precoding resource block group PRG, which are described in detail below with reference to the accompanying drawings.

The method for determining a precoding resource block group PRG and the method for indicating a precoding resource block group PRG provided in embodiments of this application may be applied to any SBFD mode. For example, the methods may be applied to at least one of the following SBFD modes:
a DUD mode in which a DL subband, an UL subband, and a DL subband are sequentially distributed;
a UD mode in which an UL subband and a DL subband are sequentially distributed;
a DU mode in which a DL subband and an UL subband are sequentially distributed; or
a UDU mode in which an UL subband, a DL subband, and an UL subband are sequentially distributed.

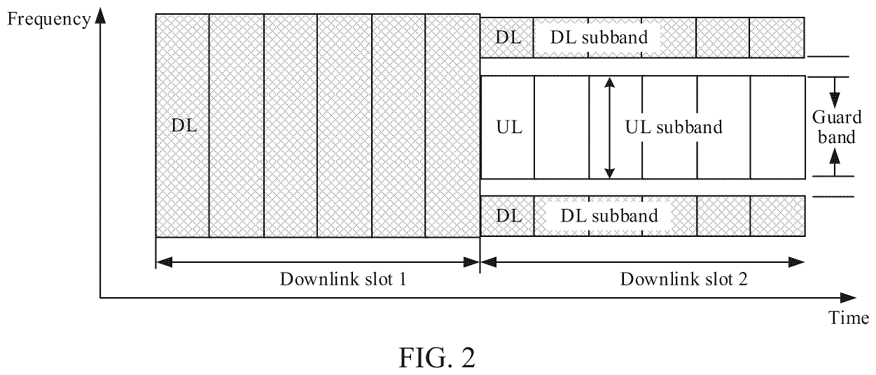

As shown in FIG. 2, for a downlink slot, there are the following two cases:
Case 1. The network side device configures a downlink Bandwidth Part (BWP) of the downlink slot for the UE, as shown by a slot 1 in FIG. 2.
Case 2. The network side device configures, for the UE, a DL subband and an UL subband of the downlink slot, and a guard interval between the DL subband and the UL subband, as shown by a slot 2 in FIG. 2.

The downlink slot 2 in FIG. 2 is an SBFD mode, and may be the DUD mode.

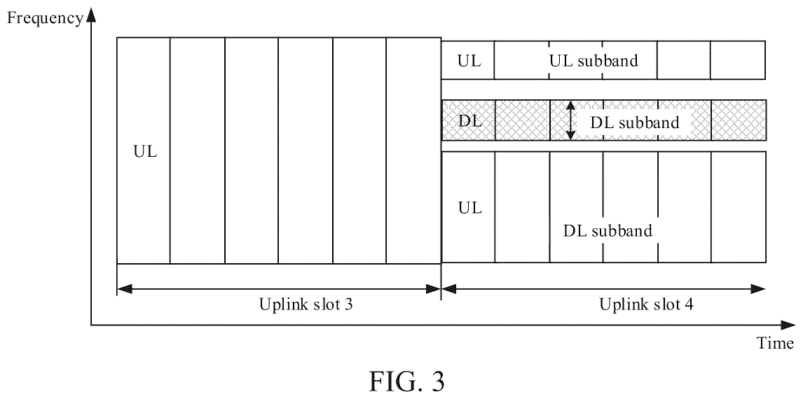

As shown in FIG. 3, for an uplink slot, there are the following two cases:
Case 3. The network side device configures an UL BWP of the uplink slot for the UE, as shown by a slot 3 in FIG. 3.
Case 4. The network side device configures, for the UE, an UL subband and a DL subband of the uplink slot, and a guard interval between the DL subband and the UL subband, as shown by a slot 4 in FIG. 3.

The uplink slot 4 in FIG. 3 is an SBFD scenario, and may be the UDU mode.

The method for determining a precoding resource block group PRG provided in embodiments of this application is described below.

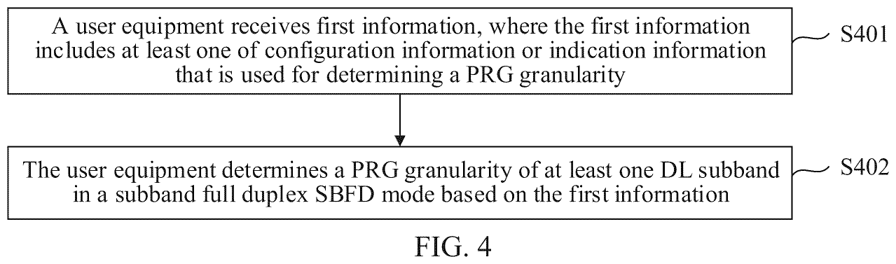

As shown in FIG. 4, the method for determining a precoding resource block group PRG provided in embodiments of this application may include:
Step 401: A user equipment receives first information, where the first information includes at least one of configuration information or indication information that is used for determining a PRG granularity.

The configuration information may be a Radio Resource Control (RRC) protocol.

The indication information may be Downlink Control Information (DCI).

Generally, the configuration information is used for configuring the PRG granularity for the UE, and the indication information indicates a PRG granularity set for the UE. This is described in detail below by using different cases.

Step 402. The user equipment determines a PRG granularity of at least one DL subband in a subband full duplex SBFD mode based on the first information.

The PRG granularity is a PRG size.

In some embodiments, the user equipment may determine the PRG granularity of the at least one DL subband in the SBFD mode based on the first information when the network side device allocates a frequency domain resource to the user equipment on the at least one DL subband in the SBFD mode. That the network side device allocates a frequency domain resource to the UE on the at least one DL subband in the SBFD mode may include: A frequency domain resource is semi-persistently allocated to the UE on the at least one DL subband in the SBFD mode, for example, a Semi-Persistent Scheduling (SPS) PDSCH; or a frequency domain resource is dynamically scheduled for the UE on the at least one DL subband in the SBFD mode by using the DCI. For brevity, semi-persistently allocating frequency domain resources or dynamically scheduling frequency domain resources are briefly referred to as allocating frequency domain resources below.

The PRG granularity indicated in the first information may include, but is not limited to, at least one of wideband, a specific value, or a specific range. On this basis, the foregoing step 402 may include at least one of the following:
(1) in a case that the PRG granularity indicated by the first information is wideband, the user equipment determines that the PRG granularity of the at least one DL subband in the SBFD mode is the wideband or a fixed value (for example, 2 or 4);
(2) in a case that the PRG granularity indicated by the first information is a specific value (for example, 4), the user equipment determines that the PRG granularity of the at least one DL subband in the SBFD mode is the specific value; or
(3) in a case that the PRG granularity indicated by the first information is a specific range (for example, 2-wideband or 4-wideband), the user equipment determines that the PRG granularity of the at least one DL subband in the SBFD mode is a fixed value (for example, 2 or 4) or determines, based on a quantity of consecutive physical resource blocks PRBs allocated to the UE, the PRG granularity of the at least one DL subband in the SBFD mode.

The following respectively provides descriptions for the foregoing three items.

The foregoing item (1) may include at least one of the following:
\textcircled{1} In a case that the user equipment does not have a dynamic downlink PRB bundling capability, if a PRB bundling type (prb-BundlingType) configured by the configuration information in the first information is static bundling (staticBundling) and the PRG granularity is the wideband, the user equipment determines that the PRG granularity of the at least one DL subband in the SBFD mode is the wideband or the fixed value.

For example, when a granularity (bundleSize) of a PRG bundling length configured in the configuration information is wideband, that is, when bundleSize-wideband, a manner in which the UE determines the PRG granularity of the at least one DL subband in the SBFD mode may include at least one of the following:
determining, by the user equipment if the network side device allocates the frequency domain resource to the user equipment in the at least one DL subband, that the PRG granularity of the at least one DL subband is the wideband;
determining, by the user equipment if the frequency domain resource allocated by the network side device to the user equipment spans at least two DL subbands, that the PRG granularity of the at least one DL subband is 2 (that is, the fixed value is 2); or
determining, by the user equipment if the frequency domain resource allocated by the network side device to the user equipment spans at least two DL subbands, that the PRG granularity of the at least one DL subband is 4 (that is, the fixed value is 4).

A PRG granularity of 2 means that precoding on two PRBs in one PRG is the same, and a PRG granularity of 4 means that precoding on four PRBs in one PRG is the same.

The following uses an example to describe actual application of the foregoing \textcircled{1}.

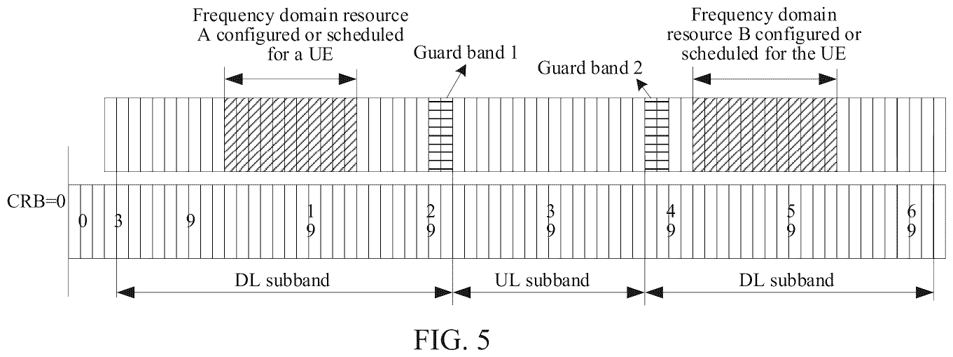

In a case that the PRG granularity configured in the configuration information is the wideband, as shown in FIG. 5, the network side device respectively allocates a frequency domain resource A and a frequency domain resource B to the UE in two DL subbands in the SBFD mode, and both the frequency domain resource A and the frequency domain resource B are consecutive PRBs. Then, the UE may determine PRG granularities of the two DL subbands (that is, all DL subbands) as the wideband. The UE may further determine to use precoding M on the frequency domain resource A, and use precoding N on the frequency domain resource B, where M and N may be the same or may be different. Generally, the UE does not expect to be allocated non-consecutive PRBs in the same DL subband.

\textcircled{2} In a case that the user equipment has a dynamic downlink PRB bundling capability, the user equipment determines that the PRG granularity of the at least one DL subband in the SBFD mode is the wideband or the fixed value based on that a PRB bundling type configured by the configuration information in the first information is dynamic bundling and the PRG granularity is the wideband and a PRG granularity set indicated by the indication information in the first information.

In a case, if the indication information indicates a first granularity set of the PRG, the PRB bundling type configured by the configuration information is the dynamic bundling, and the first granularity set of the PRG is the wideband, it is determined that the PRG granularity of the at least one DL subband in the SBFD mode is the wideband or the fixed value.

For example, when the indication information indicates bundleSizeSet1 (the first granularity set) of the PRG, and bundleSizeSet1=wideband is configured in the configuration information, the determining that the PRG granularity of the at least one DL subband in the SBFD mode is the wideband or the fixed value based on that a PRB bundling type configured by the configuration information in the first information is dynamic bundling and the PRG granularity is the wideband and a PRG granularity set indicated by the indication information in the first information may include at least one of the following:
determining, by the user equipment if the network side device allocates the frequency domain resource to the user equipment in the at least one DL subband, that the PRG granularity of the at least one DL subband is the wideband;
determining, by the user equipment if the frequency domain resource allocated by the network side device to the user equipment spans at least two DL subbands, that the PRG granularity of the at least one DL subband is 2 (that is, the fixed value is 2); or
determining, by the user equipment if the frequency domain resource allocated by the network side device to the user equipment spans at least two DL subbands, that the PRG granularity of the at least one DL subband is 4 (that is, the fixed value is 4).

In another case, if the indication information indicates a second granularity set of the PRG, the PRB bundling type configured by the configuration information is the dynamic bundling, and the second granularity set of the PRG is the wideband, it is determined that the PRG granularity of the at least one DL subband in the SBFD mode is the wideband or the fixed value.

For example, when the indication information indicates bundleSizeSet2 (the second granularity set) of the PRG, and bundleSizeSet2=wideband is configured in the configuration information, the determining that the PRG granularity of the at least one DL subband in the SBFD mode is the wideband or the fixed value based on that a PRB bundling type configured by the configuration information in the first information is dynamic bundling and the PRG granularity is the wideband and a PRG granularity set indicated by the indication information in the first information may include at least one of the following:
determining, by the user equipment if the network side device allocates the frequency domain resource to the user equipment in the at least one DL subband, that the PRG granularity of the at least one DL subband is the wideband;
determining, by the user equipment if the frequency domain resource allocated by the network side device to the user equipment spans at least two DL subbands, that the PRG granularity of the at least one DL subband is 2 (that is, the fixed value is 2); or
determining, by the user equipment if the frequency domain resource allocated by the network side device to the user equipment spans at least two DL subbands, that the PRG granularity of the at least one DL subband is 4 (that is, the fixed value is 4).

\textcircled{3}. In a case that the user equipment has a dynamic downlink physical resource block PRB bundling capability, if a PRB bundling type configured by the configuration information in the first information is semi-persistent bundling and the PRG granularity is the wideband, the user equipment determines that the PRG granularity of the at least one DL subband in the SBFD mode is the wideband or the fixed value. This case is similar to \textcircled{1} in the foregoing item (1), and for a specific example, refer to the foregoing text.

The foregoing item (2) may include at least one of the following:

\textcircled{1}. In a case that the user equipment does not have a dynamic downlink PRB bundling capability, if a PRB bundling type (prb-BundlingType) configured by the configuration information in the first information is static bundling (staticBundling) and the PRG granularity is the specific value, the user equipment determines that the PRG granularity of the at least one DL subband in the SBFD mode is the specific value.

For example, when a granularity of a PRG bundling length (bundleSize) configured in the configuration information is 4, that is, when bundleSize=n4, a manner in which the UE determines the PRG granularity of the at least one DL subband in the SBFD may include:
determining, by the user equipment if the frequency domain resource allocated by the network side device to the user equipment spans at least two DL subbands, that the PRG granularity of the at least one DL subband is 4 (that is, the specific value is 4).

In a case that the user equipment has a dynamic downlink PRB bundling capability, if the indication information in the first information indicates a first granularity set of the PRG, a PRB bundling type configured by the configuration information in the first information is dynamic bundling, and the first granularity set of the PRG is the specific value, the user equipment determines that the PRG granularity of the at least one DL subband in the SBFD mode is the specific value.

For example, when the indication information indicates bundleSizeSet1 (the first granularity set) of the PRG, and bundleSizeSet1=n4 is configured in the configuration information, the determining that the PRG granularity of the at least one DL subband in the SBFD mode is the specific value may include:
determining, by the user equipment if the frequency domain resource allocated by the network side device to the user equipment spans at least two DL subbands, that the PRG granularity of the at least one DL subband is 4 (that is, the specific value is 4).

\textcircled{3}. In a case that the user equipment has a dynamic downlink physical resource block PRB bundling capability, if the indication information indicates a second granularity set of the PRG, the PRB bundling type configured by the configuration information is dynamic bundling, and the second granularity set of the PRG is the specific value, the user equipment determines that the PRG granularity of the at least one DL subband in the SBFD is the specific value.

For example, when the indication information indicates bundleSizeSet2 (the second granularity set) of the PRG, and bundleSizeSet2=n4 is configured in the configuration information, the determining that the PRG granularity of the at least one DL subband in the SBFD mode is the specific value may include:
determining, by the user equipment if the frequency domain resource allocated by the network side device to the user equipment spans at least two DL subbands, that the PRG granularity of the at least one DL subband is 4 (that is, the specific value is 4).

\textcircled{4}. In a case that the user equipment has a dynamic downlink physical resource block PRB bundling capability, if a PRB bundling type configured by the configuration information in the first information is semi-persistent bundling and the PRG granularity is the specific value, the user equipment determines that the PRG granularity of the at least one DL subband in the SBFD mode is the specific value. This case is similar to in the foregoing item (2), and for a specific example, refer to the foregoing text.

The foregoing item (3) may include:
In a case that the user equipment has a dynamic downlink physical resource block PRB bundling capability, if the indication information in the first information indicates a first granularity set of the PRG, a PRB bundling type configured by the configuration information in the first information is dynamic bundling, and the first granularity set of the PRG is the specific range, the user equipment determines that the PRG granularity of the at least one DL subband in the SBFD mode is the fixed value, or determines, based on the quantity of consecutive physical resource blocks PRBs allocated to the UE, the PRG granularity of the at least one DL subband in the SBFD mode.

The determining that the PRG granularity of the at least one DL subband in the SBFD mode is the fixed value may include:
determining, by the user equipment in a case that the specific range is n2-wideband (that is, bundleSizeSet1=n2-wideband) and if the frequency domain resource allocated by the network side device to the user equipment spans at least two DL subbands, that the PRG granularity of the at least one DL subband is 2 (that is, the fixed value is 2); and
determining, by the user equipment in a case that the specific range is n4-wideband (that is, bundleSizeSet1=n4-wideband) and if the frequency domain resource allocated by the network side device to the user equipment spans at least two DL subbands, that the PRG granularity of the at least one DL subband is 2 (that is, the fixed value is 2), and/or the PRG granularity of the at least one DL subband is 4 (that is, the fixed value is 4).

The determining, based on a quantity of consecutive physical resource blocks PRBs allocated to the UE, the PRG granularity of the at least one DL subband in the SBFD mode may include:
if the quantity of consecutive physical resource blocks PRBs allocated to the UE is greater than a specific threshold, determining that the PRG granularity of the at least one DL subband in the SBFD mode is the wideband; and if the quantity of consecutive physical resource blocks PRBs allocated to the UE is not greater than the specific threshold, determining that the PRG granularity of the at least one DL subband in the SBFD mode is a minimum value of the specific range.

For example, in a case that the specific range is n2-wideband (that is, bundleSizeSet1=n2-wideband), if the quantity of consecutive physical resource blocks PRBs allocated to the UE is greater than the specific threshold, it is determined that the PRG granularity of the at least one DL subband in the SBFD mode is the wideband; and if the quantity of consecutive physical resource blocks PRBs allocated to the UE is not greater than the specific threshold, it is determined that the PRG granularity of the at least one DL subband in the SBFD mode is 2.

For another example, in a case that the specific range is n4-wideband (that is, bundleSizeSet1=n4-wideband), if the quantity of consecutive physical resource blocks PRBs allocated to the UE is greater than the specific threshold, it is determined that the PRG granularity of the at least one DL subband in the SBFD mode is the wideband; and if the quantity of consecutive physical resource blocks PRBs allocated to the UE is not greater than the specific threshold, it is determined that the PRG granularity of the at least one DL subband in the SBFD mode is 4.

The feature threshold is configured by the network side device. In an example, the feature threshold may be a half of a width of the DL subband, that is, the feature threshold=(DL subband size)/2.

It should be noted that, in embodiments of this application, the PRG granularity is the wideband, which means that the PRG granularity is equal to a quantity of consecutive PRBs scheduled by the UE.

In some embodiments, after the foregoing step 401, the method shown in FIG. 4 may further include:
in a case that the user equipment does not have the dynamic downlink physical resource block PRB bundling capability and if the PRB bundling type configured by the first information is the static bundling and the PRG granularity is the wideband, precoding on the consecutive PRBs allocated to the user equipment in each subband of the at least one DL subband being the same.

Further, in the foregoing embodiment, if the network side device allocates the frequency domain resource to the user equipment in at least one DL subband, as long as the UE determines that a PRG granularity of one DL subband in the at least one DL subband is the wideband, a PRG granularity of another DL subband in the at least one DL subband is also the wideband. That is, PRG granularities of all DL subbands in the at least one DL subband are consistent.

For example, if bundleSizeSet1=n2-wideband is configured in the configuration information, in a case that the frequency domain resource allocated by the network side device to the user equipment spans at least two DL subbands, if the quantity of consecutive PRBs allocated to the user equipment is greater than the specific threshold, the user equipment may determine that PRG granularities of all DL subbands are the wideband; and if the quantity of consecutive PRBs allocated to the user equipment is not greater than the specific threshold, the user equipment may determine that PRG granularities of all DL subbands are 2.

For another example, if bundleSizeSet1=n4-wideband is configured in the configuration information, in a case that the frequency domain resource allocated by the network side device to the user equipment spans at least two DL subbands, if the quantity of consecutive PRBs allocated to the user equipment is greater than the specific threshold, the user equipment may determine that PRG granularities of all DL subbands are the wideband; and if the quantity of consecutive PRBs allocated to the user equipment is not greater than the specific threshold, the user equipment may determine that PRG granularities of all DL subbands are 4. By analogy, and details are not described herein again.

In some embodiments, if the network side device is not configured with a granularity of a PRB bundling length or a granularity set of a bundling length, the UE may default to a PRG granularity of 2 used by the consecutive PRBs allocated on each DL subband.

In some embodiments, some restrictions on configuration of the PRG granularity may exist. For example, if Resource Block Group (RBG)=2 or vrb-ToPRB-Interleaver=n2, PRG size=n4 cannot be configured.

In some embodiments, the user equipment does not expect an allocated frequency domain resource to span two subbands in the at least one DL subband.

In some embodiments, the user equipment does not expect to be allocated a non-consecutive PRB in one DL subband of the at least one DL subband.

Configuration of the PRG granularity in the method for determining a precoding resource block group PRG provided in embodiments of this application and interpretation of the PRG granularity by the UE are described below by using a complete example.

Generally, there is a plurality of formats of the DCI, for example, DCI format 0 series and DCI format 1 series.

(1) For a PDSCH scheduled by using a DCI format 1_0, the UE always assumes that the PRG granularity is 2, that is, the PRG size=n2 (that is, 2PRB).

(2) A process of determining, by the UE, the PRG granularity of the at least one DL subband in the SBFD mode for a PDSCH scheduled by using a DCI format 1_1 or a DCI format 1_2 may include:
a. If the UE does not have a dynamicPRB-BundlingDL capability, the gNB can only statically configure the PRG size by using the RRC. In this case, the prb-BundlingType is staticBundling. If a network allocates the frequency domain resource to the UE in the at least one DL subband, the UE can perform the following behaviors:
   if bundleSize=n4 is configured, the UE uses a PRG size=n4 (that is, 4 PRB) in all the DL subbands; and.
   if bundleSize-wideband is configured, the UE uses PRG size=wideband on consecutive PRBs scheduled in each DL subband.
b. If the UE has a dynamicPRB-BundlingDLcapability, the gNB may dynamically configure the PRG size by using the following (1): RRC+DCI, or statically configure the PRG size by using the following (2): RRC.

(1) If the gNB uses an RRC+DCI dynamic configuration, in this case, the prb-BundlingType is the dynamicBundling.
A DCI field, PRB bundling size indicator, uses one bit to indicate bundleSizeSet1 (that is, the first granularity set) or bundleSizeSet2 (that is, the second granularity set). A value of 1 indicates that bundleSizeSet1 is used, and a value of 0 indicates that bundleSizeSet2 is used.
   bundleSizeSet1={n4, wideband, n2-wideband, n4-wideband}
   bundleSizeSet2={n4, wideband}
If a DCI field, PRB bundling size indicator, indicates bundleSizeSet1, the UE can perform the following behaviors:
   if bundleSizeSet1=n4 is configured, the UE uses PRG size=n4 in all DL subbands;
   if bundleSizeSet1=wideband is configured, the UE uses PRG size-wideband in each subband;
   if bundleSizeSet1=n2-wideband is configured,
      for each DL subband, if the quantity of consecutive PRBs scheduled by the network for the UE>(DL subband size)/2, the UE uses PRG size-wideband in the DL subband; otherwise, the UE uses PRG size=n2 in the DL subband; and
   if bundleSizeSet1=n4-wideband is configured,
      for each DL subband, if the quantity of consecutive PRBs scheduled by the network for the UE>(DL subband size)/2, the UE uses PRG size-wideband in the DL subband; otherwise, the UE uses PRG size=n4 in the DL subband.
If a DCI field, PRB bundling size indicator, indicates bundleSizeSet2, the UE can perform the following behaviors:
   if bundleSizeSet2=n4 is configured, the UE uses PRG size=n4 in all DL subbands; and
   if bundleSizeSet2-wideband is configured, the UE uses PRG size=wideband in each DL subband.

(2) An RRC static configuration, as described in a above.
c. If the gNB is not configured with a bundleSize(Set), PRG size=n2 defaults.
d. If a restriction condition on the PRG size exists, for example:
   If RBG=2 or vrb-ToPRB-Interleaver=n2, PRG size=n4 cannot be configured.

It should be noted that, when the PRG size is configured as the wideband, it means that a PRG size of each DL subband is equal to a quantity of consecutive PRBs scheduled by the UE in the DL subband. In addition, resources allocated to the UE should be consecutive PRBs, and precoding on consecutive PRBs in each DL subband is the same.

According to the method for determining a precoding resource block group PRG provided in embodiments of this application, because the user equipment may determine the PRG granularity of the at least one DL subband in the subband full duplex SBFD mode based on at least one of configuration information or indication information, that is, the user equipment may determine the PRG granularity for the DL subband, the user equipment can better adapt to the SBFD scenario, thereby improving channel estimation accuracy.

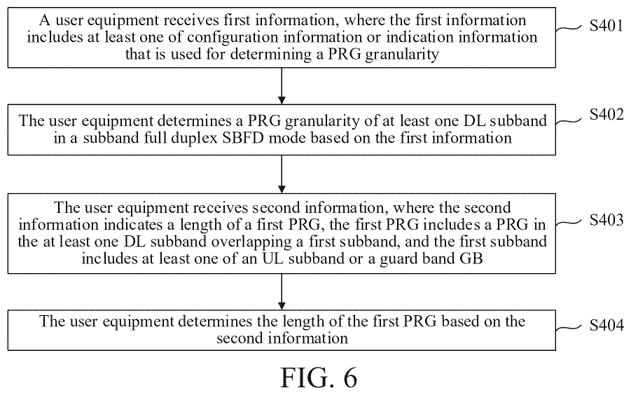

In some embodiments, as shown in FIG. 6, in addition to including the foregoing step 401, the method for determining a precoding resource block group (PRG) may further include:

Step 403. The user equipment receives second information, where the second information indicates a length of a first PRG, the first PRG includes a PRG in the at least one DL subband overlapping a first subband, the first subband includes at least one of an UL subband or a guard band (GB), and the length of the first PRG indicates a quantity of PRBs that can be used for transmission in one PRG.

The second information may be high layer information.

In an example, the first PRG includes a PRG in the at least one DL subband overlapping the UL subband. The first length indicates a length of the first PRG overlapping a low frequency part of the UL subband in the at least one DL subband, and the second length indicates a length of the first PRG overlapping a high frequency part of the UL subband in the at least one DL subband (a size of the first PRG).

For example, the network side device may configure the following parameters for the UE in the high layer information:
PRGsize1 ENUMERATED {1,2,3}
PRGsize2 ENUMERATED {1,2,3}

PRGsize1 indicates the length of the first PRG overlapping the low frequency part of the UL subband in the at least one DL subband, and PRGsize2 indicates the length of the first PRG overlapping the high frequency part of the UL subband in the at least one DL subband.

Step 404. The user equipment determines the length of the first PRG based on the second information.

If the network side device schedules the first PRG, the user equipment determines the length of the first PRG based on the second information.

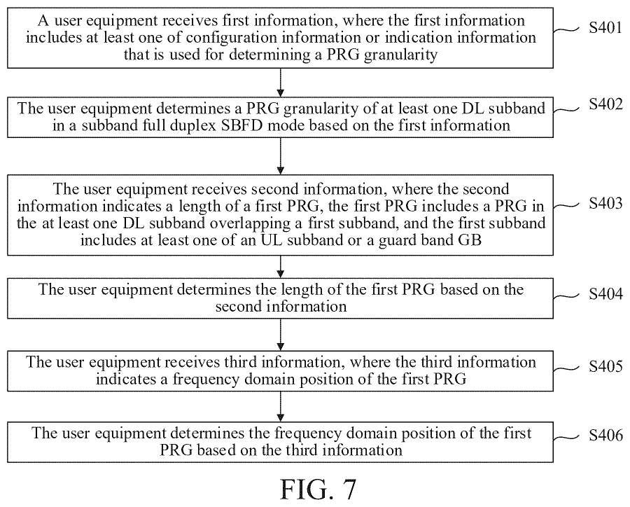

Further, as shown in FIG. 7, in addition to including at least one of the foregoing step 401, step 402, step 403, or step 404, the method for determining a precoding resource block group PRG provided in embodiments of this application may further include:
Step 405. The user equipment receives third information, where the third information indicates a frequency domain position of the first PRG.
Step 406. The user equipment determines the frequency domain position of the first PRG based on the third information.

It may be understood that after having the length (size) and the frequency domain position of the first PRG, the UE may accurately receive consecutive PRBs in the first PRG, thereby improving channel estimation accuracy.

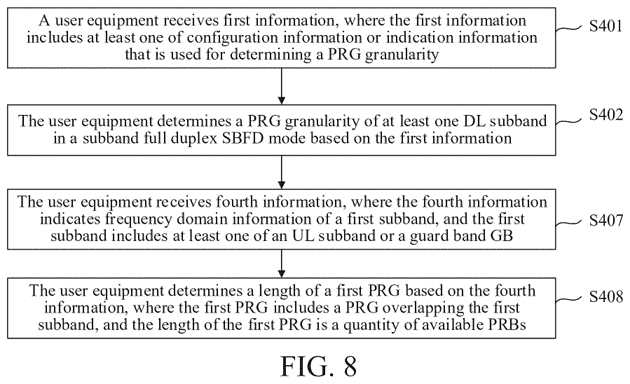

Further, as shown in FIG. 8, in addition to including at least one of the foregoing step 401, step 402, step 403, step 404, step 405, or step 406, the method for determining a precoding resource block group PRG provided in embodiments of this application may further include:
Step 407. The user equipment receives fourth information, where the fourth information indicates frequency domain information of a first subband, and the first subband includes at least one of an UL subband or a guard band GB.

The frequency domain information includes at least one of the frequency domain position or the width (size).

Step 408. The user equipment determines the length of the first PRG based on the fourth information, where the first PRG includes a PRG in the at least one DL subband overlapping the first subband.

If the network side device schedules the first PRG, the user equipment determines the length of the first PRG based on the fourth information.

It may be understood that, if the network side device configures frequency domain positions and widths of the UL subband and the guard band (GB) for the UE, when the network side semi-persistently configures or dynamically schedules the PRG (the first PRG) overlapping the UL subband or the guard band in the at least one DL subband, the UE may determine a quantity of actually available PRBs in an affected PRG based on the frequency domain position and/or the width of the UL subband and/or the guard band, and it is assumed that the PRBs use the same precoding.

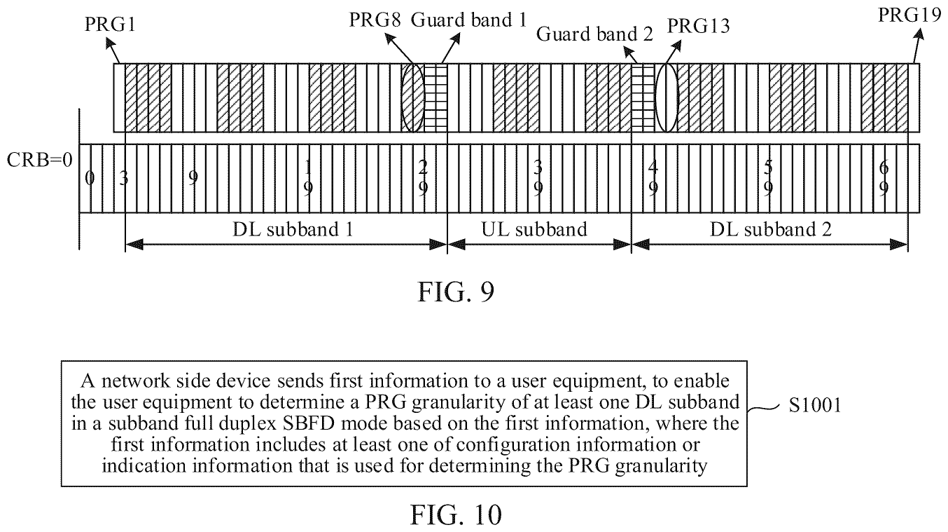

For example, as shown in FIG. 9, a BWP bandwidth is 70 PRBs. Compared with a common PRB, a sequence number of a starting PRB is 3 (for ease of description, description is made herein based on a number of a CRB). It is assumed that the PRG granularity configured by the network side device is 4, the BWP is divided into 19 PRGs. A first PRG (for example, a PRG1 in FIG. 9) and a last PRG (for example, a PRG19 in FIG. 9) include one PRB, and the remaining PRGs include 4 PRBs.

Further, it is assumed that the network side device configures frequency domain positions of UL subbands to be PRB32 to PRB47, and a total of 16 PRBs.

For indication of the guard band, the network side device may configure the frequency domain position and/or the width of the guard band in carrier-level signaling, UL subband signaling, or downlink BWP signaling. In an indication manner, the guard band is configured as a PRB beside the UL subband:
GB: {size1(lower frequency), size2(Higher frequency)}

For example, in FIG. 9, GB: {2,2} indicates that two PRBs on a left side of an edge PRB32 of the UL subband are used as GBs (for example, a guard band 1: PRB30 to PRB31 in FIG. 9), and two PRBs on a right side of an edge PRB47 of the UL subband are used as GBs (for example, a guard band 2: PRB48 to PRB49 in FIG. 9). In this way, two PRBs at low frequencies adjacent to the UL subband are used as one guard band, and two PRBs at high frequencies adjacent to the UL subband are used as another guard band.

Another indication manner is:
GB: {0, . . . ,273}, and indicates, in a bitmap form, which PRB is used as a guard band.

For example, 1 is indicated at bit positions of 30, 31, 48, and 49, to indicate that the four PRBs are used as guard bands.

It may be understood that, when the network side device semi-persistently configures or dynamically indicates the PRG granularity, for a PRG overlapping the guard band or the UL subband, the UE may determine, based on at least one of the foregoing second information, third information, or fourth information, that the length of the PRG is a quantity of available PRBs in the PRG. For example, when the network side device indicates that the PRG granularity is 4, when the PRG8 and the PRG13 in FIG. 9 are scheduled, the lengths of the two PRGs are respectively two PRBs, so that the PRBs can be accurately received, thereby improving channel estimation performance.

In FIG. 9, a CRB is a common resource block.

In some embodiments, based on the embodiment described in any one of FIG. 6, FIG. 7, and FIG. 8, the method may further include: determining, by the user equipment, that precoding on PRBs included in the first PRG is the same.

It should be noted that, a PRG overlapped with the first subband may also be considered as a PRG overlapped with or adjacent to the first subband, and it is difficult to effectively receive a PRB partially overlapped with the first subband.

The foregoing describes the method for determining a precoding resource block group PRG provided in embodiments of this application.

As shown in FIG. 10, an embodiment of this application further provides a method for indicating a precoding resource block group PRG. The method may include:
Step 1001: A network side device sends first information to a user equipment, to enable the user equipment to determine a PRG granularity of at least one DL subband in a subband full duplex SBFD mode based on the first information, where the first information includes at least one of configuration information or indication information that is used for determining the PRG granularity.

The PRG granularity is a PRG size.

The sending, by a network side device, first information to a user equipment may include: sending, by the network side device, the first information to the user equipment based on a dynamic downlink physical resource block PRB bundling capability of the user equipment.

In a case that the user equipment does not have the dynamic downlink PRB bundling capability, the first information includes the configuration information, the PRB bundling type and the PRG granularity are configured in the configuration information, and the PRB bundling type is static bundling.

In a case that the user equipment has the dynamic downlink PRB bundling capability, the first information includes the configuration information and the indication information, the PRB bundling type and the PRG granularity are configured in the configuration information, the PRB bundling type is dynamic bundling, and a granularity set of a PRG is indicated in the indication information.

In a case that the user equipment has the dynamic downlink PRB bundling capability, the first information includes the configuration information, the PRB bundling type and the PRG granularity are configured in the configuration information, and the PRB bundling type is semi-persistent bundling.

In some embodiments, some restriction conditions on configuration of the PRG granularity may exist. For example, if Resource Block Group (RBG)=2 or vrb-ToPRB-Interleaver=n2, PRG size=n4 cannot be configured.

The method for indicating a precoding resource block group PRG provided in embodiments of this application may further include:
sending, by the network side device, second information to the user equipment, where the second information indicates a length of a first PRG, the first PRG includes a PRG in the at least one DL subband overlapping a first subband, and the first subband includes at least one of an UL subband or a guard band GB.

The second information may be high layer information.

In an example, the first PRG includes a PRG in the at least one DL subband overlapping the UL subband. The second information includes a first length and a second length, where the first length indicates a length of the first PRG overlapping a low frequency part of the UL subband in the at least one DL subband, and the second length indicates a length of the first PRG overlapping a high frequency part of the UL subband in the at least one DL subband.

For example, the network side device may configure the following parameters for the UE in the high layer information:
PRGsize1 ENUMERATED {1,2,3}
PRGsize2 ENUMERATED {1,2,3}

PRGsize1 indicates the length of the first PRG overlapping the low frequency part of the UL subband in the at least one DL subband, and PRGsize2 indicates the length of the first PRG overlapping the high frequency part of the UL subband in the at least one DL subband.

The method for indicating a precoding resource block group PRG provided in embodiments of this application may further include:
sending, by the network side device, third information to the user equipment, where the third information indicates a frequency domain position of the first PRG.

It may be understood that after having the length (size) and the frequency domain position of the first PRG, the UE may accurately receive consecutive PRBs in the first PRG, thereby improving channel estimation accuracy.

The method for indicating a precoding resource block group PRG provided in embodiments of this application may further include:
sending, by the network side device, fourth information to the user equipment, where the fourth information indicates frequency domain information of a first subband, the first subband includes at least one of an UL subband or a guard band GB, the frequency domain information includes at least one of a frequency domain position or a width, the frequency domain information is used for determining a length of a first PRG by the user equipment, and the first PRG includes a PRG in the at least one DL subband overlapping the first subband.

It may be understood that, if the network side device configures frequency domain positions and widths of the UL subband and the guard band (GB) for the UE, when the network side semi-persistently configures or dynamically schedules the PRG (the first PRG) overlapping the UL subband or the guard band in the at least one DL subband, the UE may determine a quantity of actually available PRBs in an overlapped PRG based on the frequency domain position and/or the width of the UL subband and/or the guard band, and it is assumed that the PRBs use the same precoding.

According to the method for indicating a precoding resource block group PRG provided in embodiments of this application, after the network side device sends the first information to the user equipment, the user equipment may determine the PRG granularity of the at least one DL subband in the subband full duplex SBFD mode based on the first information, that is, the user equipment may determine the PRG granularity for the DL subband. Therefore, the user equipment can better adapt to the SBFD scenario, thereby improving channel estimation accuracy.

It should be noted that, for the method for determining a precoding resource block group PRG provided in embodiments of this application, an execution body may be an apparatus for determining a precoding resource block group PRG. In embodiments of this application, an example in which the apparatus for determining a precoding resource block group PRG performs the method for determining a precoding resource block group PRG is used to describe the apparatus for determining a precoding resource block group PRG provided in embodiments of this application. Similarly, for the method for indicating information provided in embodiments of this application, an execution body may be an apparatus for indicating a precoding resource block group PRG. In embodiments of this application, an example in which the apparatus for indicating information performs the method for indicating information is used to describe the apparatus for indicating information provided in embodiments of this application.

The following describes an apparatus for determining a precoding resource block group PRG and an apparatus for indicating a precoding resource block group PRG that are provided in embodiments of this application with reference to the accompanying drawings. The apparatus for determining a precoding resource block group PRG provided in embodiments of this application corresponds to the method for determining a precoding resource block group PRG provided in embodiments of this application, and the apparatus for indicating a precoding resource block group PRG provided in embodiments of this application corresponds to the method for indicating a precoding resource block group PRG provided in embodiments of this application. Therefore, the apparatus for determining a precoding resource block group PRG and the apparatus for indicating a precoding resource block group PRG provided in embodiments of this application are briefly described. For detailed content, refer to the descriptions in the foregoing method embodiments.

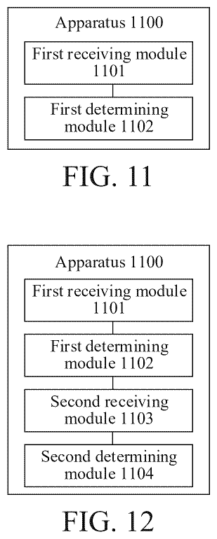

As shown in FIG. 11, an embodiment of this application provides an apparatus 1100 for determining a precoding resource block group PRG. The apparatus 1100 may be applied to a user equipment. The apparatus 1100 may include a first receiving module 1101 and a first determining module 1102.

The first receiving module 1101 is configured to receive first information, where the first information includes at least one of configuration information or indication information that is used for determining a PRG granularity.

The configuration information may be a Radio Resource Control (RRC) protocol.

The indication information may be Downlink Control Information (DCI).

Generally, the configuration information is used for configuring the PRG granularity for the UE, and the indication information indicates a PRG granularity set for the UE.

The first determining module 1102 is configured to determine a PRG granularity of at least one DL subband in a subband full duplex SBFD mode based on the first information.

The PRG granularity is a PRG size.

In some embodiments, the first determining module 1102 may determine, when the network side device allocates a frequency domain resource to the user equipment on the at least one DL subband in the SBFD mode, the PRG granularity of the at least one DL subband in the SBFD mode based on the first information. That the network side device allocates a frequency domain resource to the UE on the at least one DL subband in the SBFD mode may include: A frequency domain resource is semi-persistently allocated to the UE on the at least one DL subband in the SBFD mode, for example, a Semi-Persistent Scheduling (SPS) PDSCH; or a frequency domain resource is dynamically scheduled for the UE on the at least one DL subband in the SBFD mode by using the DCI. For brevity, semi-persistently allocating frequency domain resources or dynamically scheduling frequency domain resources are briefly referred to as allocating frequency domain resources below.

The PRG granularity indicated in the first information may include, but is not limited to, at least one of wideband, a specific value, or a specific range. On the basis of this, for details about how the first determining module 1102 determines the PRG granularity of the at least one DL subband in the SBFD mode based on the first information, refer to the foregoing description for step 402, and details are not described herein again.

It should be noted that, the apparatus shown in FIG. 11 can implement the method shown in FIG. 4 and can achieve the same technical effects. Therefore, the description of the apparatus is simple, and refer to the foregoing description of the embodiment shown in FIG. 4 for the associated part.

In some embodiments, the apparatus shown in FIG. 11 may further include:
a fifth determining module, configured to: in a case that a dynamic downlink physical resource block PRB bundling capability is not possessed and if the PRB bundling type configured by the first information is the static bundling and the PRG granularity is the wideband, assume that precoding on consecutive PRBs allocated to the user equipment in each subband of the at least one DL subband is the same.

In some embodiments, if the network side device is not configured with a granularity of a PRB bundling length or a granularity set of a bundling length, the UE may default to a PRG granularity of 2 used by the consecutive PRBs allocated on each DL subband.

In some embodiments, some restriction conditions on configuration of the PRG granularity may exist. For example, if Resource Block Group (RBG)=2 or vrb-ToPRB-Interleaver=n2, PRG size=n4 cannot be configured.

As shown in FIG. 12, an embodiment of this application provides an apparatus 1100 for determining a precoding resource block group PRG. In addition to the first receiving module 1101 and the first determining module 1102, the apparatus 1100 may further include: a second receiving module 1103 and a second determining module 1104.

The second receiving module 1103 is configured to receive second information, where the second information indicates a length of a first PRG, the first PRG includes a PRG in the at least one DL subband overlapping a first subband, and the first subband includes at least one of an UL subband or a guard band GB.

The second information may be high layer information.

In an example, the first PRG includes a PRG in the at least one DL subband overlapping the UL subband. The second information includes a first length and a second length, where the first length indicates a length of the first PRG overlapping a low frequency part of the UL subband in the at least one DL subband, and the second length indicates a length of the first PRG overlapping a high frequency part of the UL subband in the at least one DL subband (a size of the first PRG).

For example, the network side device may configure the following parameters for the UE in the high layer information:
PRGsize1 ENUMERATED {1,2,3}
PRGsize2 ENUMERATED {1,2,3}

PRGsize1 indicates the length of the first PRG in the at least one DL subband overlapping the low frequency part of the UL subband, and PRGsize2 indicates the length of the first PRG in the at least one DL subband overlapping the high frequency part of the UL subband.

The second determining module 1104 is configured to determine the length of the first PRG based on the second information.

It should be noted that, the apparatus shown in FIG. 12 can implement the method shown in FIG. 6 and can achieve the same technical effects. Therefore, the description of the apparatus is simple, and refer to the foregoing description of the embodiment shown in FIG. 6 for the associated part.

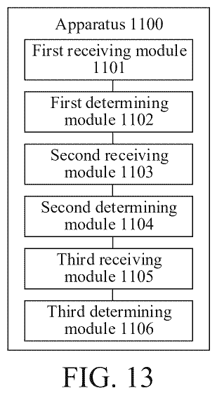

As shown in FIG. 13, an embodiment of this application provides an apparatus 1100 for determining a precoding resource block group PRG. In addition to the first receiving module 1101, the first determining module 1102, the second receiving module 1103, and the second determining module 1104, the apparatus 1100 may further include: a third receiving module 1105 and a third determining module 1106.

The third receiving module 1105 is configured to receive third information, where the third information indicates a frequency domain position of the first PRG.

The third determining module 1106 is configured to determine the frequency domain position of the first PRG based on the third information.

It may be understood that after having the length (size) and the frequency domain position of the first PRG, the UE may accurately receive consecutive PRBs in the first PRG, thereby improving channel estimation accuracy.

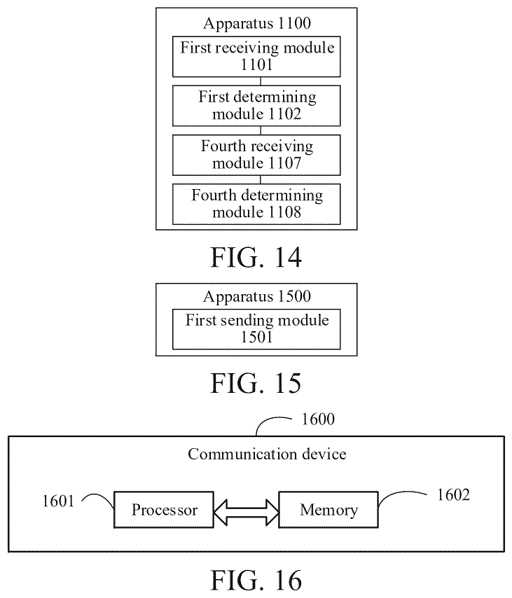

As shown in FIG. 14, an embodiment of this application provides an apparatus 1100 for determining a precoding resource block group PRG. In addition to the first receiving module 1101 and the first determining module 1102, the apparatus 1100 may further include: a fourth receiving module 1107 and a fourth determining module 1108.

The fourth receiving module 1107 is configured to receive fourth information, where the fourth information indicates frequency domain information of a first subband, and the first subband includes at least one of an UL subband or a guard band GB.

The frequency domain information includes at least one of the frequency domain position or the width (size).

The fourth determining module 1108 is configured to determine a length of a first PRG based on the fourth information, where the first PRG includes a PRG in the at least one DL subband overlapping the first subband, and the length of the first PRG is a quantity of available PRBs.

It may be understood that, if the network side device configures frequency domain positions and widths of the UL subband and the guard band (GB) for the UE, when the network side semi-persistently configures or dynamically schedules the PRG (the first PRG) overlapping the UL subband or the guard band in the at least one DL subband, the UE may determine a quantity of actually available PRBs in an affected PRG based on the frequency domain position and/or the width of the UL subband and/or the guard band, and it is assumed that the PRBs use the same precoding.

In some embodiments, the PRBs included in the first PRG use the same encoding.

It should be noted that, the apparatus shown in FIG. 14 can implement the method shown in FIG. 8 and can achieve the same technical effects. Therefore, the description of the apparatus is simple, and refer to the foregoing description of the embodiment shown in FIG. 8 for the associated part.

As shown in FIG. 15, an embodiment of this application further provides an apparatus 1500 for indicating a precoding resource block group PRG. The apparatus 1500 may include: a first sending module 1501.

The first sending module 1501 is configured to send first information to a user equipment, to enable the user equipment to determine a PRG granularity of at least one DL subband in a subband full duplex SBFD mode based on the first information, where the first information includes at least one of configuration information or indication information that is used for determining the PRG granularity.

The PRG granularity is a PRG size.

In some embodiments, the first sending module 1501 is configured to send the first information to the user equipment based on a dynamic downlink physical resource block PRB bundling capability of the user equipment.

In a case that the user equipment does not have the dynamic downlink PRB bundling capability, the first information includes the configuration information, a PRB bundling type and the PRG granularity are configured in the configuration information, and the PRB bundling type is static bundling.

In a case that the user equipment has the dynamic downlink PRB bundling capability, the first information includes the configuration information and the indication information, the PRB bundling type and the PRG granularity are configured in the configuration information, the PRB bundling type is dynamic bundling, and a granularity set of a PRG is indicated in the indication information.

In a case that the user equipment has the dynamic downlink PRB bundling capability, the first information includes the configuration information, the PRB bundling type and the PRG granularity are configured in the configuration information, and the PRB bundling type is semi-persistent bundling.

In some embodiments, some restriction conditions on configuration of the PRG granularity may exist. For example, if Resource Block Group (RBG)=2 or vrb-ToPRB-Interleaver=n2, PRG size=n4 cannot be configured.

The apparatus 1500 for indicating a precoding resource block group PRG provided in embodiments of this application may further include:
a second sending module, configured to send second information to the user equipment, where the second information indicates a length of a first PRG, the first PRG includes a PRG in the at least one DL subband overlapping a first subband, and the first subband includes at least one of an UL subband or a guard band GB.

The second information may be high layer information.

In an example, the first PRG includes a PRG in the at least one DL subband overlapping the UL subband. The second information includes a first length and a second length, where the first length indicates a length of the first PRG overlapping a low frequency part of the UL subband in the at least one DL subband, and the second length indicates a length of the first PRG overlapping a high frequency part of the UL subband in the at least one DL subband (a size of the first PRG).

For example, the network side device may configure the following parameters for the UE in the high layer information:
PRGsize1 ENUMERATED {1,2,3}
PRGsize2 ENUMERATED {1,2,3}

PRGsize1 indicates the length of the first PRG overlapping the low frequency part of the UL subband in the at least one DL subband, and PRGsize2 indicates the length of the first PRG overlapping the high frequency part of the UL subband in the at least one DL subband.

The apparatus 1500 for indicating a precoding resource block group PRG provided in embodiments of this application may further include:
a third sending module, configured to send third information to the user equipment, where the third information indicates a frequency domain position of the first PRG.

It may be understood that after having the length (size) and the frequency domain position of the first PRG, the UE may accurately receive consecutive PRBs in the first PRG, thereby improving channel estimation accuracy.

The apparatus 1500 for indicating a precoding resource block group PRG provided in embodiments of this application may further include:
a fourth sending module, configured to send fourth information to the user equipment, where the fourth information indicates frequency domain information of a first subband, the first subband includes at least one of an UL subband or a guard band GB, the frequency domain information includes at least one of a frequency domain position or a width, the frequency domain information is used for determining a length of a first PRG, and the first PRG includes a PRG in the at least one DL subband overlapping the first subband.

It may be understood that, if the network side device configures frequency domain positions and widths of the UL subband and the guard band (GB) for the UE, when the network side semi-persistently configures or dynamically schedules the PRG (the first PRG) overlapping the UL subband or the guard band in the at least one DL subband, the UE may determine a quantity of actually available PRBs in an affected PRG based on the frequency domain position and/or the width of the UL subband and/or the guard band, and it is assumed that the PRBs use the same precoding.

It should be noted that, the apparatus shown in FIG. 15 can implement the method shown in FIG. 10 and can achieve the same technical effects. Therefore, the description of the apparatus is simple, and refer to the foregoing description of the embodiment shown in FIG. 10 for the associated part.

It should be noted that, the apparatus for determining a precoding resource block group PRG in embodiments of this application may be an electronic device, for example, an electronic device having an operating system, or may be a component, for example, an integrated circuit or a chip, in an electronic device. The electronic device may be a user equipment or may be another device other than a user equipment. For example, the user equipment may include, but is not limited to, the type of the user equipment 11 listed above, and another device may be a server, a Network Attached Storage (NAS), and the like. This is not specifically limited in embodiments of this application.

As shown in FIG. 16, an embodiment of this application further provides a communication device 1600, including a processor 1601 and a memory 1602, where the memory 1602 stores a program or instructions executable on the processor 1601. For example, when the communication device 1600 is a user equipment, the program or instructions is executed by the processor 1601 to implement the steps of embodiments of the foregoing method for determining a precoding resource block group PRG, and the same technical effects can be achieved. When the communication device 1600 is a network side device, the program or the instructions is executed by the processor 1601 to implement the steps of embodiments of the foregoing method for indicating a precoding resource block group PRG, and the same technical effects can be achieved. To avoid repetition, details are not described herein again.

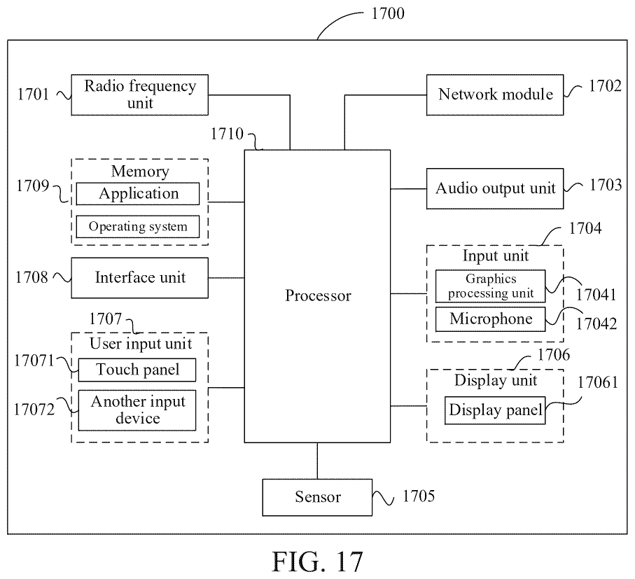

An embodiment of this application further provides a user equipment, including a processor and a communication interface. The processor is configured to determine, based on first information received from a network side device, second information used by the network side device on a frequency domain resource allocated to the user equipment by at least one DL subband, where the first information includes at least one of configuration information or indication information that is used for determining the second information, and the second information includes a precoding resource block group PRG granularity. The user equipment embodiment corresponds to the foregoing user equipment-side method embodiment, and the various implementation processes and implementations of the foregoing method embodiments can be applied to the user equipment embodiment, and can achieve the same technical effects. FIG. 17 is a schematic diagram of a hardware structure of a user equipment that implements embodiments of this application.

The user equipment 1700 includes, but is not limited to: at least some components such as a radio frequency unit 1701, a network module 1702, an audio output unit 1703, an input unit 1704, a sensor 1705, a display unit 1706, a user input unit 1707, an interface unit 1708, a memory 1709, and a processor 1710.

A person skilled in the art may understand that the user equipment 1700 further includes a power supply (such as a battery) for supplying power to the components. The power supply may be logically connected to the processor 1710 by using a power supply management system, thereby implementing functions, such as charging, discharging, and power consumption management, by using the power supply management system. The structure of the user equipment shown in FIG. 17 does not constitute a limitation on the user equipment, and the user equipment may include more or fewer components than those shown in the figure, or some components may be combined, or a different component deployment may be used. Details are not described herein again.

It should be understood that, in embodiments of this application, the input unit 1704 may include a Graphics Processing Unit (GPU) 17041 and a microphone 17042. The graphics processing unit 17041 performs processing on image data of a static picture or a video that is obtained by an image acquisition apparatus (for example, a camera) in a video acquisition mode or an image acquisition mode. The display unit 1706 may include a display panel 17061, for example, the display panel 17061 may be configured in a form such as a liquid crystal display or an organic light-emitting diode. The user input unit 1707 includes at least one of a touch panel 17071 or another input device 17072. The touch panel 17071 is also referred to as a touch screen. The touch panel 17071 may include two parts: a touch detection apparatus and a touch controller. The another input device 17072 may include, but is not limited to, a physical keyboard, a functional key (such as a volume control key or a switch key), a track ball, a mouse, and a joystick, and details are not described herein again.

In embodiments of this application, the radio frequency unit 1701 receives downlink data from a network side device and then transmits the downlink data to the processor 1710 for processing. In addition, the radio frequency unit 1701 may send uplink data to the network side device. Generally, the radio frequency unit 1701 includes, but is not limited to, an antenna, an amplifier, a transceiver, a coupler, a low noise amplifier, a duplexer, and the like.

The memory 1709 may be configured to store a software program or instructions and various data. The memory 1709 may mainly include a first storage region for storing a program or instructions and a second storage region for storing data. The first storage region may store an operating system, an application program or instructions required by at least one function (for example, a sound playback function and an image playback function), or the like. In addition, the memory 1709 may include a volatile memory or a non-volatile memory, or the memory 1709 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch link DRAM (SLDRAM), and a Direct Rambus RAM (DRRAM). The memory 1709 in embodiments of this application includes, but is not limited to, these memories and any other suitable types of memories.

The processor 1710 may include one or more processing units. In some embodiments, the processor 1710 integrates an application processor and a modem processor. The application processor mainly processes operations related to an operating system, a user interface, and an application program. The modem processor mainly processes a wireless communication signal, such as a baseband processor. It may be understood that, the foregoing modem processor may not be integrated into the processor 1710.

The radio frequency unit 1701 is configured to receive first information, where the first information includes at least one of configuration information or indication information that is used for determining a PRG granularity.

The processor 1710 is configured to determine a PRG granularity of at least one DL subband in a subband full duplex SBFD mode based on the first information.

In embodiments of this application, because the user equipment 1700 may determine the PRG granularity of the at least one DL subband in the subband full duplex SBFD mode based on at least one of the configuration information or the indication information, that is, the user equipment may determine the PRG granularity for the DL subband, the user equipment 1700 can better adapt to the SBFD scenario, thereby improving channel estimation accuracy.

An embodiment of this application further provides a network side device, including a processor and a communication interface. The communication interface is configured to send first information to a user equipment, to enable the user equipment to determine a PRG granularity of at least one DL subband in a subband full duplex SBFD mode based on the first information, where the first information includes at least one of configuration information or indication information that is used for determining the PRG granularity. The network side device embodiment corresponds to the foregoing network side device method embodiment, and the various implementation processes and implementations of the foregoing method embodiments can be applied to the network side device embodiment, and can achieve the same technical effects.

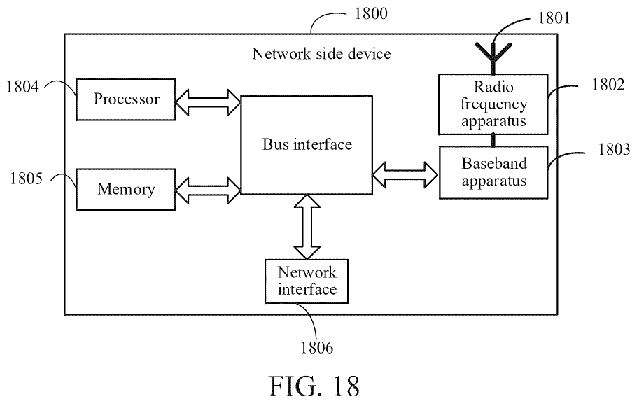

An embodiment of this application further provides a network side device. As shown in FIG. 18, the network side device 1800 includes: an antenna 1801, a radio frequency apparatus 1802, a baseband apparatus 1803, a processor 1804, and a memory 1805. The antenna 1801 is connected to the radio frequency apparatus 1802. In an uplink direction, the radio frequency apparatus 1802 receives information through the antenna 1801 and sends the received information to the baseband apparatus 1803 for processing. In a downlink direction, the baseband apparatus 1803 processes information that needs to be sent and sends the information to the radio frequency apparatus 1802. The radio frequency apparatus 1802 processes the received information and sends the received information through the antenna 1801.

The method executed by the network side device in the foregoing embodiment may be implemented in the baseband apparatus 1803. The baseband apparatus 1803 includes a baseband processor.

The baseband apparatus 1803 may include, for example, at least one baseband plate. A plurality of chips are disposed on the baseband plate. As shown in FIG. 18, one of the plurality of chips is, for example, the baseband processor, and is connected to the memory 1805 through a bus interface, to invoke a program in the memory 1805 to perform a network device operation shown in the foregoing method embodiment.

The network side device may further include a network interface 1806, and the interface is, for example, a common public radio interface (CPRI).

The network side device 1800 in embodiments of this application further includes: instructions or a program stored in the memory 1805 and executable on the processor 1804. The processor 1804 invokes the instructions or program in the memory 1805 to perform the methods executed by each module shown in FIG. 7, and can achieve the same technical effects. To avoid repetition, details are not described herein again.

An embodiment of this application further provides a readable storage medium, storing a program or instructions. The program or instructions, when executed by a processor, implements all processes of embodiments of the foregoing method for determining a precoding resource block group PRG or embodiments of the foregoing method for indicating a precoding resource block group PRG, and the same technical effects can be achieved. To avoid repetition, details are not described herein again.

The processor is a processor in the user equipment in the foregoing embodiments. The readable storage medium includes a computer-readable storage medium, for example, a computer read-only memory ROM, a random access memory RAM, a magnetic disk, or an optical disc.

An embodiment of this application further provides a chip. The chip includes a processor and a communication interface, where the communication interface is coupled to the processor, and the processor is configured to run a program or instructions, to implement all processes of embodiments of the foregoing method for determining a precoding resource block group PRG or embodiments of the foregoing method for indicating a precoding resource block group PRG, and the same technical effects can be achieved. To avoid repetition, details are not described herein again.

It should be understood that, the chip described in embodiments of this application may also be referred to as a system-level chip, a system chip, a chip system, a system on chip, or the like.

An embodiment of this application further provides a computer program/program product, where the computer program/program product is stored in a non-volatile storage medium and executed by at least one processor to implement all processes of embodiments of the foregoing method for determining a precoding resource block group PRG or embodiments of the foregoing method for indicating a precoding resource block group PRG, and the same technical effects can be achieved. To avoid repetition, details are not described herein again.

An embodiment of this application further provides a communication system. The system includes: a user equipment and a network side device, where the user equipment may be configured to perform the steps of the method for determining a precoding resource block group PRG according to FIG. 4, and the network side device may be configured to perform the steps of the method for determining a precoding resource block group PRG according to FIG. 10.

It should be noted that, the term “include”, “comprise” or any other variation thereof in this specification is intended to cover a non-exclusive inclusion, which specifies the presence of stated processes, methods, objects, or apparatuses, but does not preclude the presence or addition of one or more other processes, methods, objects, or apparatuses. Without more limitations, elements defined by the sentence “including one” does not exclude that there are still other same elements in the processes, methods, objects, or apparatuses. In addition, it should be noted that, the scope of the method and apparatus in embodiments of this application is not limited to performing functions in the order shown or discussed, and it may further include performing the functions in a substantially simultaneous manner or in reverse order according to the functions involved. For example, the described method may be performed in a different order than described, and various steps may also be added, omitted, or combined. In addition, features described with reference to some examples may be combined in other examples.

Through the descriptions of the foregoing implementations, a person skilled in the art may clearly understand that the method according to the foregoing embodiments may be implemented by means of software and a necessary general hardware platform, and may be implemented by hardware, but in many cases, the former manner is a better implementation. Based on such an understanding, the technical solutions in this application essentially or the part contributing to the conventional technologies may be implemented in the form of a computer software product. The computer software product is stored in a storage medium (for example, a ROM/RAM, a magnetic disk, or an optical disc), and includes several instructions for instructing a user equipment (which may be a mobile phone, a computer, a server, an air conditioner, a network device, or the like) to perform the method described in embodiments of this application.

Embodiments of this application are described above with reference to the accompanying drawings, but this application is not limited to the foregoing specific implementations. The foregoing specific implementations are merely exemplary and not limitative. Under the inspiration of this application, a person of ordinary skill in the art may make various variations without departing from the scope of this application and the protection of the claims, and such variations shall fall within the protection of this application.

What is claimed is:

1. A method for determining a precoding resource block group (PRG), comprising:
receiving, by a user equipment (UE), first information, wherein the first information comprises at least one of configuration information or indication information that is used for determining a PRG granularity; and
determining, by the UE, a PRG granularity of at least one downlink (DL) subband in a subband full duplex (SBFD) mode based on the first information.

2. The method according to claim 1, wherein the determining, by the UE, a PRG granularity of at least one DL subband in a SBFD mode based on the first information comprises at least one of the following:
determining, by the UE, that the PRG granularity of the at least one DL subband in the SBFD mode is wideband or a fixed value when the PRG granularity indicated by the first information is the wideband;
determining, by the UE, that the PRG granularity of the at least one DL subband in the SBFD mode is a specific value when the PRG granularity indicated by the first information is the specific value; or
determining, by the UE when the PRG granularity indicated by the first information is a specific range, that the PRG granularity of the at least one DL subband in the SBFD mode is the fixed value, or determining, based on a quantity of consecutive physical resource blocks (PRBs) allocated to the UE, the PRG granularity of the at least one DL subband in the SBFD mode.

3. The method according to claim 2, wherein the determining, by the UE, that the PRG granularity of the at least one DL subband in the SBFD mode is wideband or a fixed value when the PRG granularity indicated by the first information is the wideband comprises at least one of the following:
determining, by the UE when the UE does not have a dynamic downlink physical resource block (PRB) bundling capability and when a PRB bundling type configured by the configuration information in the first information is static bundling and the PRG granularity is the wideband, that the PRG granularity of the at least one DL subband in the SBFD mode is the wideband or the fixed value;
determining, by the UE when the UE has a dynamic downlink physical resource block (PRB) bundling capability, that the PRG granularity of the at least one DL subband in the SBFD mode is the wideband or the fixed value based on that a PRB bundling type configured by the configuration information in the first information is dynamic bundling and the PRG granularity is the wideband and a PRG granularity set indicated by the indication information in the first information; or
determining, by the UE when the UE has a dynamic downlink physical resource block (PRB) bundling capability and when a PRB bundling type configured by the configuration information in the first information is semi-persistent bundling and the PRG granularity is the wideband, that the PRG granularity of the at least one DL subband in the SBFD mode is the wideband or the fixed value.

4. The method according to claim 3, wherein the determining that the PRG granularity of the at least one DL subband in the SBFD mode is the wideband or the fixed value based on that a PRB bundling type configured by the configuration information in the first information is dynamic bundling and the PRG granularity is the wideband and a PRG granularity set indicated by the indication information in the first information comprises at least one of the following:
determining that the PRG granularity of the at least one DL subband in the SBFD mode is the wideband or the fixed value when the indication information indicates a first granularity set of the PRG, the PRB bundling type configured by the configuration information is the dynamic bundling, and the first granularity set of the PRG is the wideband; or
determining that the PRG granularity of the at least one DL subband in the SBFD mode is the wideband or the fixed value if the indication information indicates a second granularity set of the PRG, the PRB bundling type configured by the configuration information is the dynamic bundling, and the second granularity set of the PRG is the wideband.

5. The method according to claim 2, wherein the determining, by the UE, that the PRG granularity of the at least one DL subband in the SBFD mode is a specific value when the PRG granularity indicated by the first information is the specific value comprises at least one of the following:
determining, by the UE when the UE does not have a dynamic downlink physical resource block (PRB) bundling capability and when a PRB bundling type configured by the configuration information in the first information is static bundling and the PRG granularity is the specific value, that the PRG granularity of the at least one DL subband in the SBFD mode is the specific value;
determining, by the UE when the UE has a dynamic downlink physical resource block (PRB) bundling capability and when the indication information in the first information indicates a first granularity set of the PRG, a PRB bundling type configured by the configuration information in the first information is dynamic bundling, and the first granularity set of the PRG is the specific value, that the PRG granularity of the at least one DL subband in the SBFD mode is the specific value;
determining, by the UE when the UE has a dynamic downlink physical resource block (PRB) bundling capability and when the indication information indicates a second granularity set of the PRG, the PRB bundling type configured by the configuration information is dynamic bundling, and the second granularity set of the PRG is the specific value, that the PRG granularity of the at least one DL subband in the SBFD mode is the specific value; or
determining, by the UE when the UE has a dynamic downlink physical resource block (PRB) bundling capability and when a PRB bundling type configured by the configuration information in the first information is semi-persistent bundling and the PRG granularity is the specific value, that the PRG granularity of the at least one DL subband in the SBFD mode is the specific value.

6. The method according to claim 2, wherein the determining, by the UE when the PRG granularity indicated by the first information is a specific range, that the PRG granularity of the at least one DL subband in the SBFD mode is the fixed value, or determining, based on a quantity of consecutive physical resource blocks (PRBs) allocated to the UE, the PRG granularity of the at least one DL subband in the SBFD mode comprises:
determining, by the UE when the UE has a dynamic downlink physical resource block (PRB) bundling capability and when the indication information in the first information indicates a first granularity set of the PRG, a PRB bundling type configured by the configuration information in the first information is dynamic bundling, and the first granularity set of the PRG is the specific range, that the PRG granularity of the at least one DL subband in the SBFD mode is the fixed value, or determining, based on the quantity of consecutive physical resource blocks (PRBs) allocated to the UE, the PRG granularity of the at least one DL subband in the SBFD mode.

7. The method according to claim 2, wherein the determining, based on a quantity of consecutive PRBs allocated to the UE, the PRG granularity of the at least one DL subband in the SBFD mode comprises:
when the quantity of consecutive PRBs allocated to the UE is greater than a specific threshold, determining that the PRG granularity of the at least one DL subband in the SBFD mode is the wideband; and when the quantity of consecutive PRBs allocated to the UE is not greater than the specific threshold, determining that the PRG granularity of the at least one DL subband in the SBFD mode is a minimum value of the specific range.

8. The method according to claim 3, wherein after the receiving, by a UE, first information, the method further comprises:
when the UE does not have the dynamic downlink physical resource block (PRB) bundling capability and when the PRB bundling type configured by the first information is the static bundling and the PRG granularity is the wideband, precoding on consecutive PRBs allocated to the UE in each subband of the at least one DL subband being the same.

9. The method according to claim 1, wherein the UE does not expect to be allocated frequency domain resources to span two subbands in the at least one DL subband.

10. The method according to claim 1, wherein the UE does not expect to be allocated a non-consecutive physical resource block (PRB) in one DL subband of the at least one DL subband.

11. The method according to claim 1, wherein the SBFD mode comprises at least one of the following:
a DUD mode in which a DL subband, an uplink (UL) subband, and a DL subband are sequentially distributed;
a UD mode in which an UL subband and a DL subband are sequentially distributed;
a DU mode in which a DL subband and an UL subband are sequentially distributed; or
a UDU mode in which an UL subband, a DL subband, and an UL subband are sequentially distributed.

12. The method according to claim 1, further comprising:
receiving, by the UE, second information, wherein the second information indicates a length of a first PRG, the first PRG comprises a PRG in the at least one DL subband overlapping a first subband, and the first subband comprises at least one of an uplink (UL) subband or a guard band (GB); and
determining, by the UE, the length of the first PRG based on the second information.

13. The method according to claim 12, wherein:
the first PRG comprises a PRG in the at least one DL subband overlapping the UL subband; and
the second information comprises a first length and a second length, wherein the first length indicates a length of the first PRG overlapping a low frequency part of the UL subband in the at least one DL subband, and the second length indicates a length of the first PRG overlapping a high frequency part of the UL subband in the at least one DL subband.

14. The method according to claim 12, further comprising:
receiving, by the UE, third information, wherein the third information indicates a frequency domain position of the first PRG; and
determining, by the UE, the frequency domain position of the first PRG based on the third information.

15. The method according to claim 1, further comprising:
receiving, by the UE, fourth information, wherein the fourth information indicates frequency domain information of a first subband, the first subband comprises at least one of an uplink (UL) subband or a guard band (GB), and the frequency domain information comprises at least one of a frequency domain position or a width; and
determining, by the UE, a length of a first PRG based on the fourth information, wherein the first PRG comprises a PRG in the at least one DL subband overlapping the first subband, and the length of the first PRG is a quantity of available PRBs.

16. The method according to claim 15, further comprising:
determining, by the UE, that precoding on available PRBs comprised in the first PRG is the same.

17. A method for indicating a precoding resource block group (PRG), comprising:
sending, by a network side device, first information to a user equipment (UE), to enable the UE to determine a PRG granularity of at least one downlink (DL) subband in a subband full duplex (SBFD) mode based on the first information, wherein the first information comprises at least one of configuration information or indication information that is used for determining the PRG granularity.

18. The method according to claim 17, wherein the sending, by a network side device, first information to a UE comprises:
sending, by the network side device, the first information to the UE based on a dynamic downlink physical resource block (PRB) bundling capability of the UE.

19. The method according to claim 18, wherein:
when the UE does not have the dynamic downlink PRB bundling capability, the first information comprises the configuration information, a PRB bundling type and the PRG granularity are configured in the configuration information, and the PRB bundling type is static bundling;
when the UE has the dynamic downlink PRB bundling capability, the first information comprises the configuration information and the indication information, the PRB bundling type and the PRG granularity are configured in the configuration information, the PRB bundling type is dynamic bundling, and a granularity set of a PRG is indicated in the indication information; and
when the UE has the dynamic downlink PRB bundling capability, the first information comprises the configuration information, the PRB bundling type and the PRG granularity are configured in the configuration information, and the PRB bundling type is semi-persistent bundling.

20. A user equipment (UE), comprising a processor and a memory storing a program or an instruction that is capable of running on the processor, wherein the program or the instruction, when executed by the processor, causes the UE to perform operations comprising:
receiving first information, wherein the first information comprises at least one of configuration information or indication information that is used for determining a PRG granularity; and
determining a PRG granularity of at least one downlink (DL) subband in a subband full duplex (SBFD) mode based on the first information.
